(19) United States
(12) Patent Application Publication
(10) Pub. No.: US 2004/0217851 A1
(43) Pub. Date: Nov. 4, 2004

(54) Obstacle detection and alerting system

(76) Inventor: James W. Reinhart, Decatur, IL (US)

Correspondence Address: CATERPILLAR INC., 100 N.E. ADAMS STREET, PATENT DEPT., PEORIA, IL, 616296490

(21) Appl. No.: 10/425,581

(22) Filed: Apr. 29, 2003

(51) Int. Cl. B60Q 1/00

(52) U.S. Cl. 340/435

(57) ABSTRACT

The present invention provides an obstacle detection system for a work machine. The obstacle detection system includes at least one sensing device and an interface device. The sensing device is configured to identify the presence of an obstacle in an area around the machine and the interface device is configured to alert an operator to the presence and position of the obstacle with respect to the machine.

### TECHNICAL FIELD

The present invention relates generally to a work machine, and more specifically to a work machine having an alert apparatus, configured to notify an operator of the presence of an obstacle near the work machine.

### BACKGROUND

Many work machines, such as large off-highway trucks, provide the machine operator only limited visibility of an area near and around the machine. As these machines move about a work site it is possible for other machines, vehicles or people to approach the work machine without the operator of the machine being aware. If the operator is unaware of such an obstacle, it is possible to have a collision.

U.S. Pat. No. 4,803,488 provides an alerting device configured to inform a driver that the vehicle is approaching a stationary obstacle. The device is configured to be automatically turned on when the vehicle is backing up. The device uses a microwave radar system to sense the presence of the obstacle. The device is connected to a back-up light circuit on the vehicle, causing the device to activate when the vehicle is in reverse. Although this system may alert a driver to the presence of an obstacle near the rear of the machine, it fails to overcome the problem of limited visibility in other areas around the machine.

The present disclosure is directed to overcoming one or more of the above-identified problems.

### SUMMARY OF THE INVENTION

In one embodiment the present disclosure provides a method of alerting the operator of a machine of the presence of an obstacle in proximity of the work machine. The method comprises the steps of: determining the presence of at least one obstacle, establishing a position of, and alerting the operator of the position of said obstacle relative to said machine.

In another embodiment, a detection system to determine obstacles based on proximity of the obstacle to a machine is provided. The detection system comprises a sensing device to determine at least one obstacle and determine the position of said obstacle. Additionally, the system includes an interface device configured to alert an operator of the position of the obstacle relative to the machine.

In another embodiment of the disclosure a method of alerting the operator of a machine of the presence of an obstacle being within a proximity of a machine is provided. The method includes the steps of detecting the presence of an obstacle and selecting a camera to provide an image of said obstacle;

### BRIEF DESCRIPTION OF THE DRAWINGS

FIG. 1 is a plan view of a work site illustrating the relationship of a work machine and obstacles nearby.

FIG. 2 is a plan view of the work machine and the positioning of the present invention thereon.

FIG. 3 is a diagrammatic representation of the detection system of the present invention.

FIG. 4 is a flow chart illustrating a method of alerting the operator of the presence of an obstacle.

### DETAILED DESCRIPTION

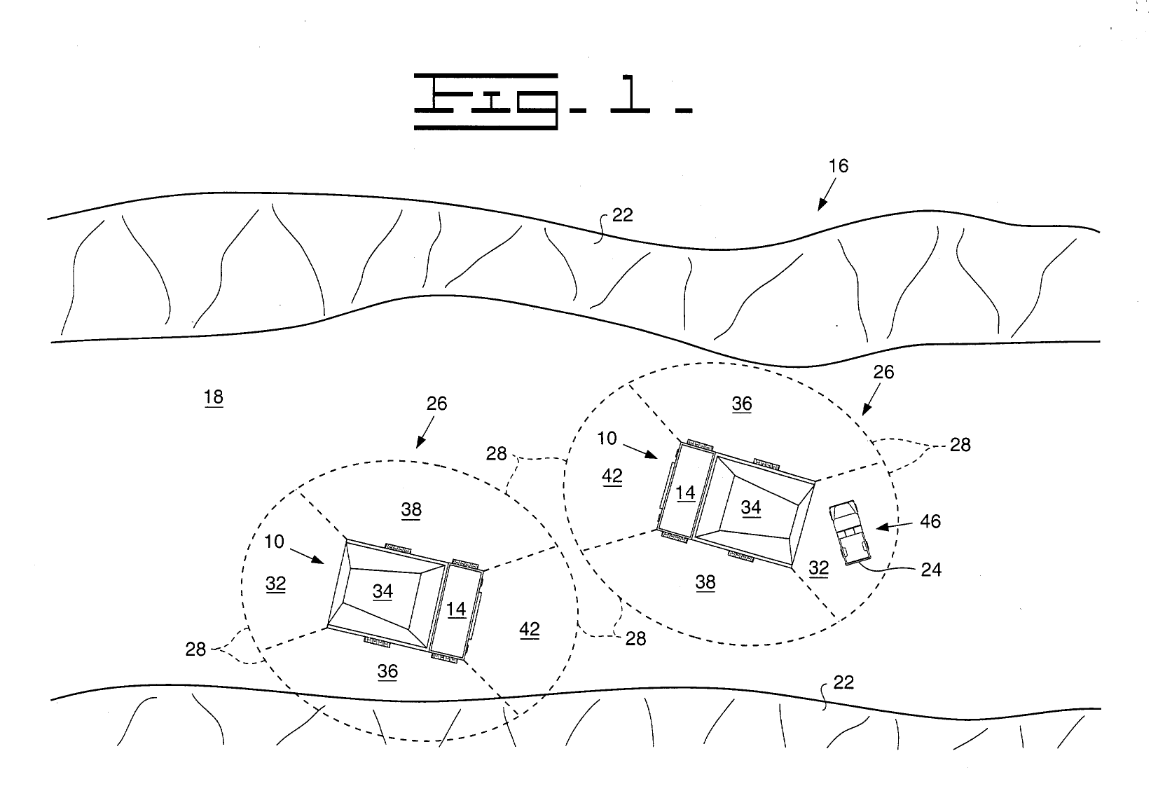

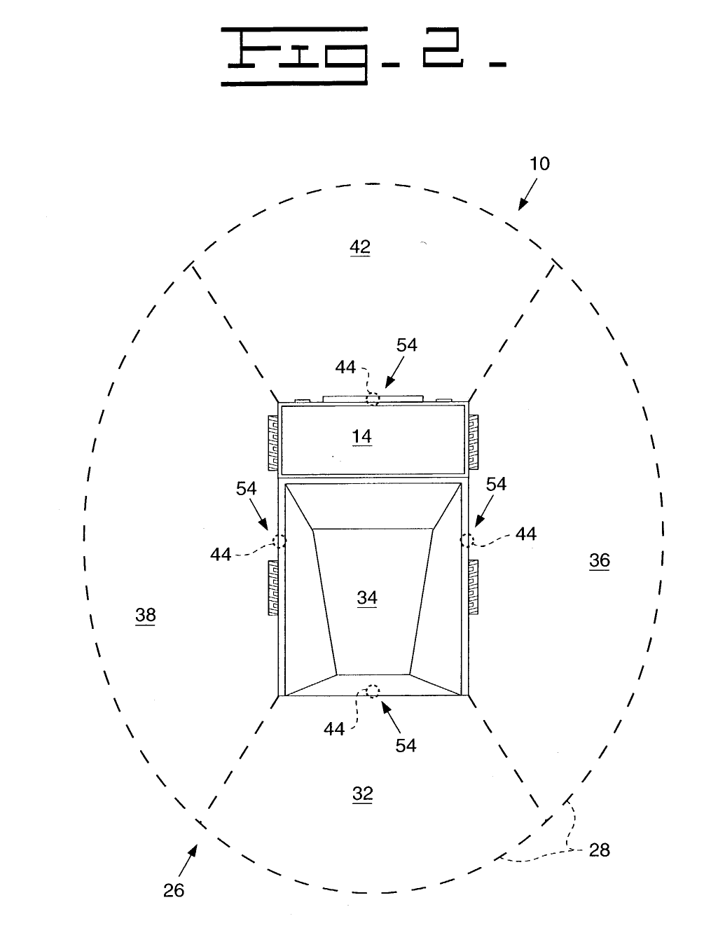

Referring to FIGS. 1 and 2, a work machine 10 having a detection system 12 of the present invention is provided. FIGS. 1 and 2 illustrate the work machine as an off-highway truck 14. It should be understood that the detection system 12 could be used with any other type of work machines 10 or vehicles, whether larger or smaller. The work machine 10 is illustrated in a working environment such as a mine site, shown generally as 16. The work machine 10 is adapted to move about the mine site 16. The mine site 16 typically includes numerous roads to be used by various work machines 10 to dig and move earth about the mine site 16. The mine site 16 may include roads 18 and walls 22, extending upward or downward from the roads 18. In comparison to the off-highway truck 14, the size of other work machines or vehicles may be significantly smaller. For example, a pickup truck 24 may be seventy five percent smaller than the off-highway truck 14.

The work machine 10, or area directly around the machine 10, may be divided into portions 26. In one embodiment, the portions 26 are defined as quadrants 28. Each quadrant 28 may represent an area where the vision of a machine operator is restricted or limited, due to such factors as mirrors, the dump body, the size of the vehicle, the distance the operator is positioned above the ground. For example, a rear quadrant 32 represents the portion of the machine behind the operator. In the rear quadrant 32 a dump body 34 positioned on the truck 14 obstructs the operators' vision. A right side quadrant 36 represents the portion 26 of the work area directly to the right of the truck 14. Vision of the right side quadrant 36 may typically be restricted in part by the dump body 34 and in part by the operator being positioned relatively high above the ground. A left quadrant 38 and front quadrant 42 are also defined.

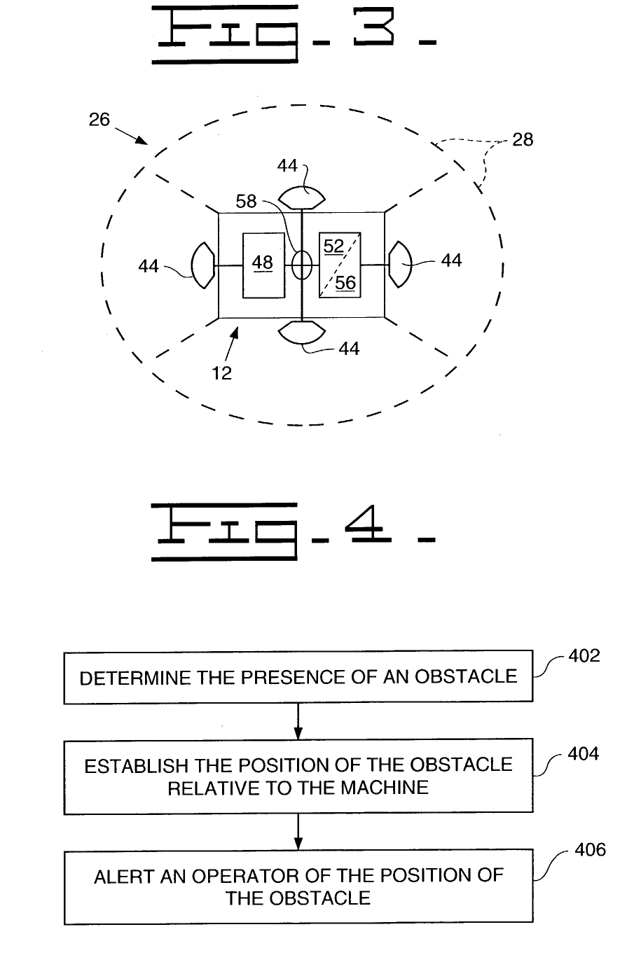

Referring now to FIG. 3, the detection system 12 of the present invention includes at least one sensing device 44 configured to identify the presence of an obstacle 46 (shown in FIGS. 1 and 2) in the work area around the machine 10 (shown in FIGS. 1 and 2), and an interface device 48 configured to alert the operator of the machine 10 of the presence of the obstacle 46. The detection system 12 may further include a system processor 52. The system processor 52 may be configured to evaluate signals from the sensing device(s) 44 and determine the position of the obstacle 46 in relation to the work machine 10. The system processor 52 in turn sends an electronic signal to the interface device 44 related to the position of the obstacle 46 relative to the work machine 10. The system processor 52 may be included in the interface device 48. The detection system 12 may be manufactured to use a number of existing technologies.

In one embodiment the sensing device 44 may be a radio system. One or more radio receivers may be positioned on the work machine 10. A portable transmitter may be attached to obstacles 46 and configured to send a signal on a radio frequency monitored by the receiver. Obstacles 46 may include people, other work machines and stationary objects. The signal from each transmitter may further be adapted, or coded, to more specifically identify who or what the obstacle is. A plurality of radio antennas 54 may be positioned on the machine 10 in a location representative of the various quadrants 28 around the work machine 10. For example, one antenna 54 being positioned on each of the front, right, rear and left portion of the machine 10. The radio receiver being connected to each of the antennas 54 in a manner to compare the strength of the radio signal being picked up by each antenna. The system processor 52 may further be configured to determine the strength of each signal, and position of multiple obstacles 46 in relation to the machine 10. For example, the system may be able to simultaneously detect the presence of multiple objects. In addition the system may be able to determine which objects the operator may be alerted to the presence of, and which object is closest and furthest away. In one embodiment it may be assumed that the obstacle 46 is located in the respective quadrant 28 having the antenna 54 providing the strongest signal.

In another embodiment, the sensing device 44 may be a radar detection system. Radar detection systems typically include a microwave radar transmitter/receiver. Radar systems are well known in the art and will not be discussed in detail. An individual radar detection system 12 may be located on the machine 10 in a position relative to each quadrant 28 or area to be monitored. In one embodiment separate radar systems may be provided on the front quadrant 42, rear quadrant 32 and side quadrants 36, 38 of the machine 10. The radar systems are further connected to the system processor 52. The system processor 52 may monitor signals from each radar system and determine if an obstacle 46 is in a quadrant 28 of the work site. The radar system may be configured to determine movement of the obstacle 46 relative to the machine 10. Further the radar system may differentiate, or cancel signals associated with the movement of the obstacle 46 relative to the machine 10.

In another embodiment, the sensing device 44 may include a vision system. Vision systems use an imaging device, such as a camera, to provide an electronic image of an area to be monitored. The camera is connected to an image processor 56 and the electronic image is compared to stored images. The stored images represent a variety of obstacles 46 that are anticipated in the operating environment of the work machine 10. The image processor 56 then determines if the electronic image matches any of the stored images. If the electronic and stored images match, a signal to alert the operator is sent. Similar to previously described sensing devices 44, multiple cameras may be positioned about the machine to monitor desired viewing regions, e.g. quadrants 28. The image processor 56 in turn sends a signal to the system processor 52 related to the position of the obstacle 28.

The interface device 48 may preferably be configured to indicate to a machine operator the position of the obstacle 46 relative to the machine 10. In one embodiment the interface device 48 may include an audible indicator positioned near the machine operator. The audible indicator may be a speaker or a tone generator. A variety of different tones or sounds may be used to indicate the relative portion of a work site an obstacle 46 is located in. For example, if an obstacle 46 is positioned in the front quadrant 28 of the machine 10, a single tone having a duration of two seconds may be sounded. In another example, if an obstacle 46 is located to the right of the work machine 10, a tone may be sounded having a one second duration, one second of silence, then followed by a two second tone. The volume of the audible indicator may additionally be varied to represent approximate distance of the obstacle from the machine. For example, the tone being louder for an obstacle located closer to the machine than for an obstacle farther from the machine.

In another embodiment, the interface device 48 may include a video monitor. The video monitor may be configured to be attached to the imaging device, e.g. camera, and display the position of the obstacle relative to the work machine. A switching device 58 may additionally be included with a video monitor. The switching device 58 being connected to the system processor and the cameras associated with the system. The switching device 58 may connect the appropriate camera to the video monitor in response to the presence of an obstacle 46. For example, the system processor 52 may receive signals associated with the presence of an obstacle 46, determine which camera is in viewing range of the obstacle 46, and control the switching device 52 to connect the appropriate camera to the monitor. The video monitor may be configured to display more than one camera image by splitting the screen. The split screen may be used when obstacles are detected in more than one quadrant 28.

Referring now to FIG. 4, a flow chart illustrates the generalized steps used by the detection system of the present invention. In the first control box 402 the detection system 12 determines the presence of an obstacle 46 near the work machine 10. Presence of the obstacle may be determined using any of, but not limited to, a radar system, a vision system, a radio system and camera system.

In the second control box 404 the detection system 12 establishes the position of the obstacle 46 relative to the work machine 10. The relative position of the obstacle 46 may be determined in a number of ways. In one embodiment, for a detection system 12 having more than one sensing device 44, the position of the obstacle 46 can be detected by evaluating which sensing device 44 sensed the obstacle 46. Using a radar or radio system, it may be possible to calculate the distance to the sensing device 44 from the obstacle 46.

In the third control box 406 the detection system 12 alerts the operator of the machine 10 of the position of the obstacle 46. The interface device 48 may signify the approximate position of the obstacle 46 using differentiated tones, and distance by altering volume. A visual display arrangement may be used having an image representing the work machine 10 and another image representing the obstacle 46. Depending on the distance between the images on the screen, the machine operator may estimate the distance that the obstacle 46 is from the machine. If multiple obstacles 46 are determined near the machine 10, multiple images may be shown. If a video monitor is used, multiple obstacles 46 may be displayed using a split screen.

### INDUSTRIAL APPLICABILITY

The detection system of the present invention may be installed on work machines 10 and vehicles. The operator of the machine 10 is provided information related to obstacles 46 that may be near the machine 10. If the machine 10 is parked and another obstacle (machine or person) approaches from an area of limited visibility, the operator of the machine 10 will be alerted and a position of the obstacle 46 can be indicated.

A detection system 12 adapted to identify the area around the machine 10 in quadrants 28 may function in the follow manner. A machine or person approaches the machine from the rear quadrant 32, the sensing device 44 in the rear quadrant 32 determines the presence of the person or machine. The sensing device 44 in turn signals the system processor 52, which in turn activates the interface device 48, e.g. audio tone and/or appropriate image. The machine 10 operator knowing that something is in the area of the machine 10 can take appropriate action to avoid an accident.

What is claimed is:

1. A detection system configured to detect obstacles based on proximity of the obstacle to a machine, said detection system comprising:
a plurality of sensing devices configured to detect the presence of at least one obstacle; and
an interface device configured to determine the position of said at least one obstacle relative to said machine, and alert an operator of said machine of said position of said obstacle relative to a portion of said machine.

2. The detection system of claim 1 wherein said sensing device is configured to identify the presence of two or more obstacles simultaneously.

3. The detection system of claim 2, wherein said interface device is configured to alert said operator of said machine which one of two or more obstacles is closest to said machine.

4. The detection system of claim 2, wherein said interface device is configured to alert said operator of said machine which one of said two or more obstacles is farthest from said machine.

5. The detection system of claim 1, wherein said interface device is a video monitor.

6. The detection system of claim 1, including a plurality of cameras, one of said cameras adapted to monitor a portion of said area adjacent to said machine.

7. The detection system of claim 6, including a switching apparatus configured to connect one of at least one of said plurality of cameras to said video camera based on the proximity of said at least one obstacle to said machine.

8. The detection system of claim 1, wherein said sensing device includes a radio system adapted to detect the proximity of said obstacle to said machine.

9. The detection system of claim 8, wherein said radio system includes at least one radio receiver and one radio transmitter, said radio receiver being adapted to receive a signal from said radio transmitter and said transmitter being positioned on at least one of said obstacles.

10. The detection system of claim 1, including a radar system adapted to determine the proximity of said obstacle to said machine.

11. The detection system of claim 1, including at least one proximity sensor configured to determine the proximity of said obstacle to said machine.

12. A method of alerting the operator of a machine of the presence of an obstacle being within a proximity of said machine, said machine having a plurality of sensing devices, said sensing devices generating a respective signal, said method comprising the steps of:
determining the presence of a first of at least one obstacle;
establishing a position of said obstacle relative to said machine in response to said signal;
alerting the operator of the position of said obstacle relative to a portion of said machine.

13. The method of claim 12, including a step of providing a plurality of cameras, each of said plurality of cameras providing a an image of a portion of an area surrounding said machine.

14. The method of claim 12, including a step of using an image recognition system to determine said presence of said obstacle.

15. A method of alerting the operator of a machine of the presence of an obstacle being within a proximity of said machine, said machine including a plurality of imaging devices, said method comprising the steps of:
detecting the presence of an obstacle; and
selecting an imaging device to provide an image of said obstacle.

16. A method as set forth in claim 15, including the step of determining the position of said obstacle relative to said machine.

17. A method as set forth in claim 15, further comprising the step of comparing said obstacle position with a viewing characteristic of said imaging device.

18. A method as set forth in claim 17, wherein the step of selecting said imaging device further includes the step of selecting said imaging device in response to said comparison.

19. A method as set forth in claim 17, wherein said viewing characteristic is a field of view.

20. A method as set forth in claim 17, wherein said viewing characteristic is a predefined viewing region relative to the machine.

21. A method as set forth in claim 15, wherein the step of detecting an obstacle further comprises the steps of receiving image data from said imaging device, analyzing said image data and detecting said obstacle in response to said analysis.

22. A method as set forth in claim 21, wherein said analysis further comprises the step of performing image recognition on said image data.

23. A method as set forth in claim 21, wherein the step of detecting the obstacle, further comprises the steps of detecting the presence of the obstacle using a radar device.

24. A method as set forth in claim 23, wherein the step of detecting further comprises the step of, detecting a motion of said obstacle.

25. A method as set forth in claim 23, wherein said step of detecting said motion of said obstacle includes a step of canceling said motion of said machine from said object.

26. A method as set forth in claim 23, further including a step of establishing a distance of said obstacle relative to said machine.

27. A method as set forth in claim 26, further including the step of selecting a camera in response to said distance being less than a predefined threshold.
